(19) United States
(12) Patent Application Publication
(10) Pub. No.: US 2007/0061140 A1
(43) Pub. Date: Mar. 15, 2007

(54) Collation regression testing

(76) Inventors: Li Li, Austin, TX (US); Su Liu, Round Rock, TX (US); Xinhua Wu, Austin, TX (US); Shunguo Yan, Austin, TX (US)

Correspondence Address: IBM CORP (YA);C/O YEE & ASSOCIATES PC, P.O. BOX 802333, DALLAS, TX, 75380, US

(21) Appl. No.: 11/227,034

(22) Filed: Sep. 15, 2005

(51) Int. Cl. G10L 15/00

(52) U.S. Cl. 704/237

(57) ABSTRACT

A method, data processing system, and computer usable code are provided for collation regression testing. Collation elements are extracted from a locale seed file into an element list. A sorted list is generated from the element list both in a released product and an updated product that is being validated. A comparison is performed of the two lists to produce test results indicating a passing or failing of the collation produced by the updated product as compared to the released product.

### BACKGROUND OF THE INVENTION

1. Field of the Invention

The present invention relates generally to regression testing. More specifically, the present invention relates to collation regression testing of products using locales.

2. Description of the Related Art

A collation is a set of rules for comparing characters in a locale. The unit of comparison is called a collation element or collation unit. By definition in globalization enablement, locale is a subset of a user's environment that defines conventions for a specified culture. A collation element may be one character, such as a, A, and 2 in English and à, “a” with accent, in French, or a sequence of characters, such as ch in French and OE in German. Collation rules determine the sorting order of collation elements of a locale. Collation rules are locale-specific, and the hence same set of collation elements can be sorted differently in different locales. For example, letters A, B, D, and c may be sorted as “A B D c” in English and “A B c D” in French.

A collation rule is normally governed by a locale-based specification or standard; for instance, Unicode collation algorithm provides a specification for how to compare Unicode elements. A collation algorithm usually consists of at least three-levels: alphabetic, diacritic, and case comparisons to ensure a consistent result. FIG. 1 depicts fragment 100 extracted from French collation rules, which shows the three-level comparison rules of the collation elements in the French locale. Because of the importance and complexity of collation rules, collation testing is one of the most critical steps in testing any globalized product. Collation regression testing is a way to test whether or not the ordering of collation elements in an updated product is identical to or compatible with the one in the released version of the same product for all the locales.

A complete collation test requires comparing any one element directly or indirectly with any other elements in the entire collation element set of a locale for all the locales the product supports. However, the existing collation test method usually only provides a sniff-type test, in which only a small set of collation elements in a locale are tested manually. For example, only a very tiny portion of the 96,382 Chinese characters in GB18030 Chinese locale are usually covered. Clearly, such a test is neither complete nor efficient.

### SUMMARY OF THE INVENTION

The different aspects of the present invention provide a method, data processing system, and computer usable code for collation regression testing. Collation elements are extracted from a locale seed file into an element list. From the element list, a sorted list is generated both in a released product and an updated product that is being validated. The two lists are compared to produce test results indicating a passing or failing of the collation produced by the updated product as compared to the released product.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a fragment extracted from French collation rules, which shows the three-level comparison rules of the collation elements in the French locale;

FIG. 2 depicts a pictorial representation of a network of data processing systems in which aspects of the present invention may be implemented;

FIG. 3 depicts a block diagram of a data processing system in which aspects of the present invention may be implemented;

FIG. 4 depicts a functional block diagram of the components used in collation regression testing in accordance with an illustrative embodiment of the present invention;

FIG. 5 depicts an exemplary collation regression test in accordance with an illustrative embodiment of the present invention; and

FIG. 6 is a flowchart of an exemplary collation regression testing method in accordance with an illustrative embodiment of the present invention.

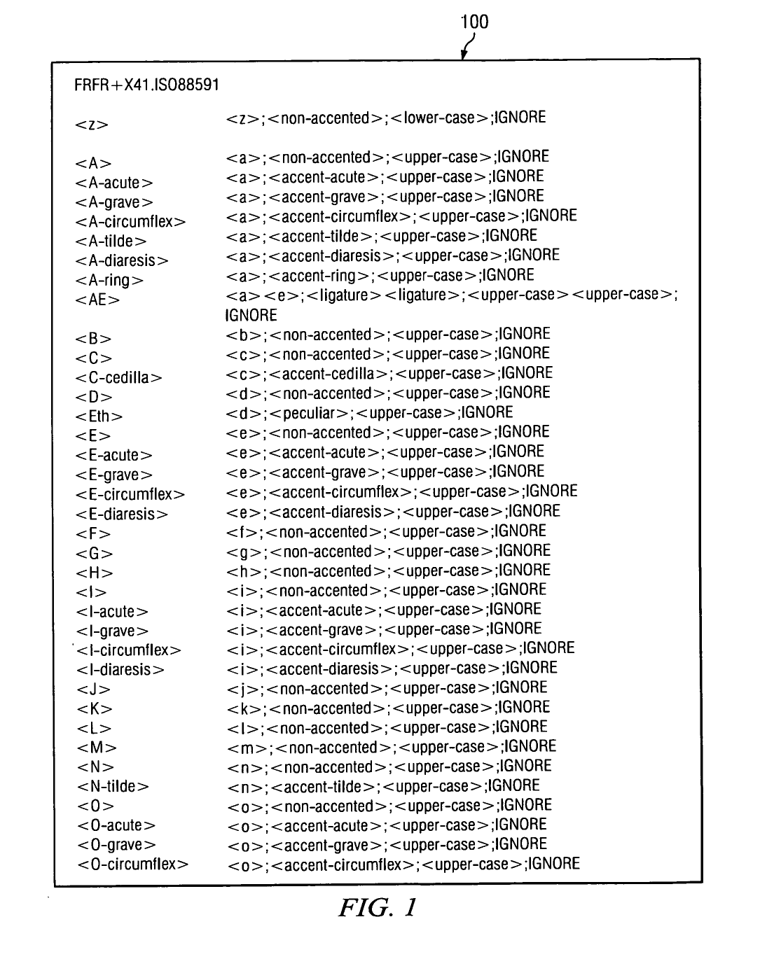

### DETAILED DESCRIPTION OF THE PREFERRED EMBODIMENT

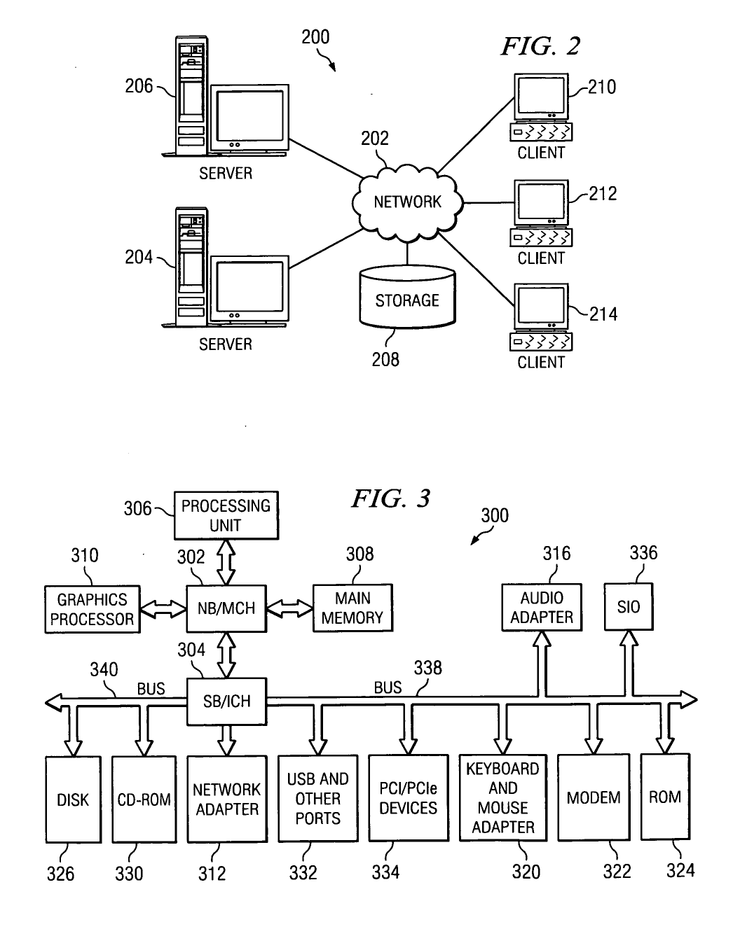

The aspects of the present invention relate to collation regression testing of products using locales. FIGS. 2-3 are provided as exemplary diagrams of data processing environments in which embodiments of the present invention may be implemented. It should be appreciated that FIGS. 2-3 are only exemplary and are not intended to assert or imply any limitation with regard to the environments in which aspects or embodiments of the present invention may be implemented. Many modifications to the depicted environments may be made without departing from the spirit and scope of the present invention.

With reference now to the figures, FIG. 2 depicts a pictorial representation of a network of data processing systems is shown in which aspects of the present invention may be implemented. Network data processing system 200 is a network of computers in which embodiments of the present invention may be implemented. Network data processing system 200 contains network 202, which is the medium used to provide communications links between various devices and computers connected together within network data processing system 200. Network 202 may include connections, such as wire, wireless communication links, or fiber optic cables.

In the depicted example, server 204 and server 206 connect to network 202 along with storage unit 208. In addition, clients 210, 212, and 214 connect to network 202. These clients 210, 212, and 214 may be, for example, personal computers or network computers. In the depicted example, server 204 provides data, such as boot files, operating system images, and applications to clients 210, 212, and 214. Clients 210, 212, and 214 are clients to server 204 in this example. Network data processing system 200 may include additional servers, clients, and other devices not shown.

In the depicted example, network data processing system 200 is the Internet with network 202 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 200 also may be implemented as a number of different types of networks, such as for example, an intranet, a local area network (LAN), or a wide area network (WAN). FIG. 2 is intended as an example, and not as an architectural limitation for different embodiments of the present invention.

With reference now to FIG. 3, a block diagram of a data processing system is shown in which aspects of the present invention may be implemented. Data processing system 300 is an example of a computer, such as server 204 or client 210 in FIG. 2, in which computer usable code or instructions implementing the processes for embodiments of the present invention may be located.

In the depicted example, data processing system 300 employs a hub architecture including north bridge and memory controller hub (MCH) 302 and south bridge and input/output (I/O) controller hub (ICH) 304. Processing unit 306, main memory 308, and graphics processor 310 are connected to north bridge and memory controller hub 302. Graphics processor 310 may be connected to north bridge and memory controller hub 302 through PCI-X bus.

In the depicted example, local area network (LAN) adapter 312 connects to south bridge and I/O controller hub 304. Audio adapter 316, keyboard and mouse adapter 320, modem 322, read only memory (ROM) 324, hard disk drive (HDD) 326, CD-ROM drive 330, universal serial bus (USB) ports and other communications ports 332, and PCI/PCIe devices 334 connect to south bridge and I/O controller hub 304 through bus 338 and bus 340. PCI/PCIe devices may include, for example, Ethernet adapters, add-in cards and PC cards for notebook computers. PCI uses a card bus controller, while PCIe does not. ROM 324 may be, for example, a flash binary input/output system (BIOS).

Hard disk drive 326 and CD-ROM drive 330 connect to south bridge and I/O controller hub 304 through bus 340. Hard disk drive 326 and CD-ROM drive 330 may use, for example, an integrated drive electronics (IDE) or serial advanced technology attachment (SATA) interface. Super I/O (SIO) device 336 may be connected to south bridge and I/O controller hub 304.

An operating system runs on processing unit 306 and coordinates and provides control of various components within data processing system 300 in FIG. 3. As a client, the operating system may be a commercially available operating system such as Microsoft® Windows® XP (Microsoft and Windows are trademarks of Microsoft Corporation in the United States, other countries, or both). An object-oriented programming system, such as the Java™ programming system, may run in conjunction with the operating system and provides calls to the operating system from Java programs or applications executing on data processing system 300 (Java is a trademark of Sun Microsystems, Inc. in the United States, other countries, or both).

As a server, data processing system 300 may be, for example, an IBM eServer™ pSeries® computer system, running the Advanced Interactive Executive (AIX®) operating system or LINUX operating system (eServer, pSeries and AIX are trademarks of International Business Machines Corporation in the United States, other countries, or both while Linux is a trademark of Linus Torvalds in the United States, other countries, or both). Data processing system 300 may be a symmetric multiprocessor (SMP) system including a plurality of processors in processing unit 306. Alternatively, a single processor system may be employed.

Instructions for the operating system, the object-oriented programming system, and applications or programs are located on storage devices, such as hard disk drive 326, and may be loaded into main memory 308 for execution by processing unit 306. The processes for embodiments of the present invention are performed by processing unit 306 using computer usable program code, which may be located in a memory such as, for example, main memory 308, read only memory 324, or in one or more peripheral devices 326 and 330.

Those of ordinary skill in the art will appreciate that the hardware in FIGS. 2-3 may vary depending on the implementation. Other internal hardware or peripheral devices, such as flash memory, equivalent non-volatile memory, or optical disk drives and the like, may be used in addition to or in place of the hardware depicted in FIGS. 2-3. Also, the processes of the present invention may be applied to a multiprocessor data processing system.

In some illustrative examples, data processing system 300 may be a personal digital assistant (PDA), which is configured with flash memory to provide non-volatile memory for storing operating system files and/or user-generated data.

A bus system may be comprised of one or more buses, such as bus 338 or bus 340 as shown in FIG. 3. Of course the bus system may be implemented using any type of communications fabric or architecture that provides for a transfer of data between different components or devices attached to the fabric or architecture. A communications unit may include one or more devices used to transmit and receive data, such as modem 322 or network adapter 312 of FIG. 3. A memory may be, for example, main memory 308, read only memory 324, or a cache such as found in north bridge and memory controller hub 302 in FIG. 3. The depicted examples in FIGS. 2-3 and above-described examples are not meant to imply architectural limitations. For example, data processing system 300 also may be a tablet computer, laptop computer, or telephone device in addition to taking the form of a PDA.

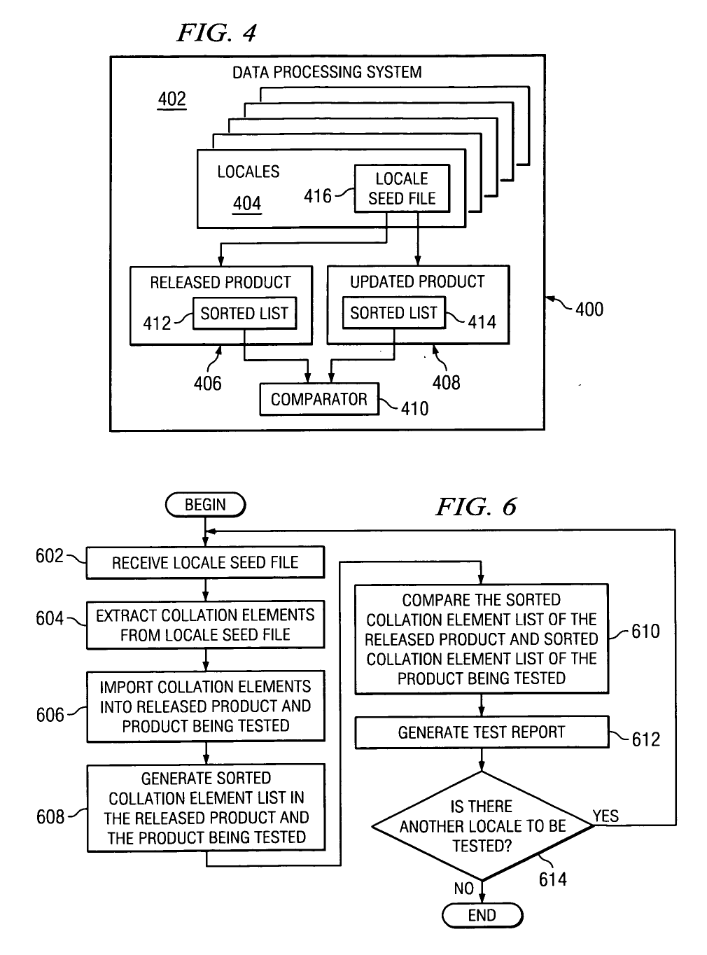

FIG. 4 depicts a functional block diagram of the components used in collation regression testing in accordance with an illustrative embodiment of the present invention. In exemplary functional block diagram 400, data processing system 402 may be a server, such as server 204 or 206 of FIG. 2, or a client computer, such as client computer 210, 212, or 214 of FIG. 2. Data processing system 402 contains locales 404, released product 406, updated product 408, and comparator 410. For each locale in locales 404, there is locale seed file 416. Locale seed file defines all collation elements, rules, time formats, monetary format and other related conventions for each locale. The collation elements for locale seed file 416 are sorted using the sorting functions of released product 406 and updated product 408. The collation element list is an unsorted list of collation elements. A sorting function, such as functions sort( ) and strcoll( ), provided by a product is able to order any number of collation elements in an order defined by the sorting function parameters for a locale. For example, letters A, b, C, d may be sorted as “A b C d” in Spanish and “A C b d” in Japanese based on the collation rules in the two different language and locales. The sorting performed on the collation elements is performed by a sorting function within released product 406 and updated product 408 and produces sorted lists 412 and 414 respectively. The sorting function provided by a product may be any type of sorting function as long as the same sorting function is used both in released product 406 and updated product 408. Many products contain sorting functions, such as sort( ) and strcoll( ) in AIX, AS400, and Linux.

Sorted list 412 from released product 406 and sorted list 414 from updated product 408 are then sent to comparator 410 for comparison to see if the collation elements in the two lists are in the identical order. The comparison performed on sorted lists 412 and 414 is performed by a comparison function within comparator 410. The comparison function compares the two lists by directly checking the collation elements' codes or binary representations without using any system functions to ensure a valid result. If the order of the collation elements is identical, the test result is successful and a test report is generated indicating the collation of the collation elements are consistent and compatible in released product 406 and updated product 408. Otherwise, a detailed error message test result is generated. The process is repeated for all locales 404 that the product supports.

The major advantage of this type of collation regression testing is that it is a complete collation test and every collation element will be compared with all other collation elements in the locale using both released product 406 and updated product 408. Thus, this type of collation regression testing is efficient and cost-saving since the collation regression test may be automated using a program to test all the locales.

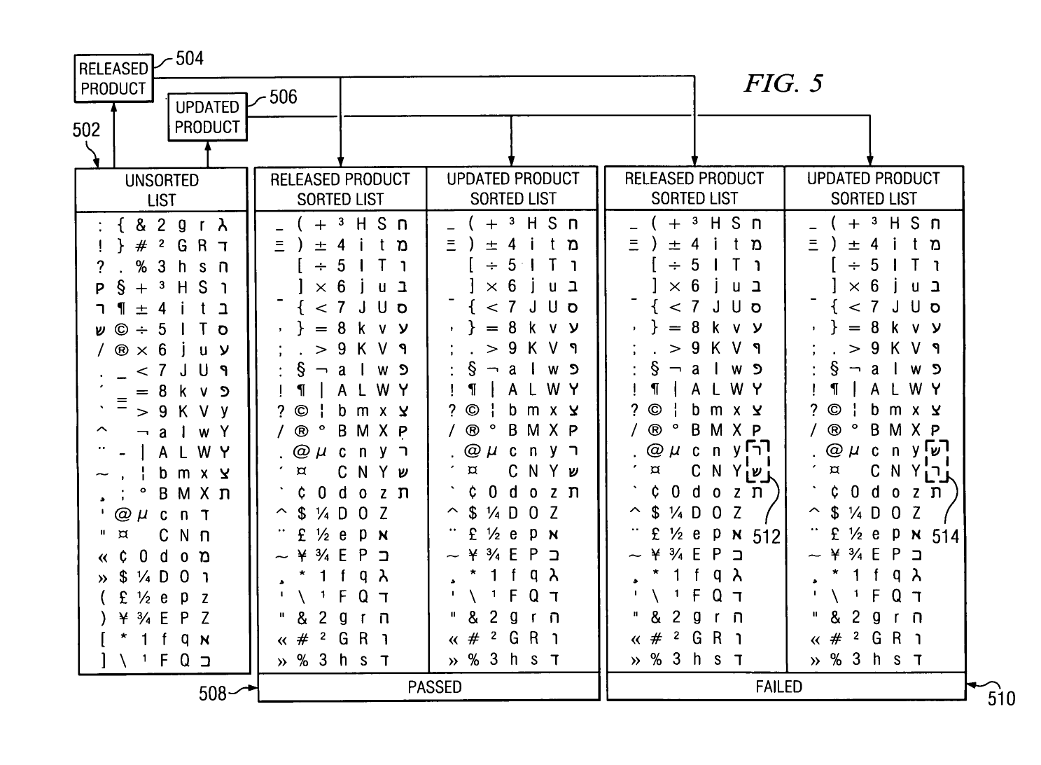

FIG. 5 depicts an exemplary collation regression test in accordance with an illustrative embodiment of the present invention. In collation regression test 500, unsorted list 502 contains an unsorted list of Hebrew collation elements. The collation elements of unsorted list 502 are imported to released product 504 and updated product 506. Both released product 504 and updated product 506 sort the collation elements and produce two sorted lists of collation elements, while the two lists are compared. A side-by-side comparison of these lists is shown in passed comparison 508 and failed comparison 510. In passed comparison 508, both released product 504 and updated product 506 sorted the collation elements in the same manner. In failed comparison 510, updated product 506 failed to sort the collation elements in the same manner as released product 504. The failure of the sorting of updated product 506 as compared to released product 504 is identified in areas 512 and 514. Area 514 depicts two characters that are reversed from the two characters shown in area 512.

FIG. 6 is a flowchart of an exemplary collation regression testing method in accordance with an illustrative embodiment of the present invention. As the operation begins, one locale seed file, such as locale seed file 416 of FIG. 4, is received from a plurality of locales, such as locales 404 of FIG. 4, that the product supports and is to be tested (step 602). The locale seed file defines all collation elements, rules, time formats, monetary format and other related conventions for each locale. The collation elements are extracted from the locale seed file and put into a collation element list (step 604). The collation element list is normally unsorted list of collation elements.

The collation element list is then imported into a release product and an updated product, such as released product 406 and updated product 408 in FIG. 4, that is to be tested (step 606). From the imported collation element list, a sorted collation element list, such as sorted lists 412 and 414 of FIG. 4, is generated both in the released product and the updated product being tested (step 608). Both the released product and the updated product being tested use internal collation functions provided by a product to sort the collation element list. If the collation functions have changed since the released product was released, because of changed collation rules or bug fixes related to collation rules, the list generated in the released product may be manually adjusted to make it compatible with the changes. This manual work should be minimal because both the collation rule changes and the defect-related element order changes will be rare and small in practice.

The sorted collation element list generated by the released product and the updated product being tested are then compared using a comparator, such as comparator 410 of FIG. 4, based on the collation element's code or binary representation in order to avoid using any collation-related functions in the system and to ensure a valid result (step 610). A report is generated indicating whether the test is successful or failed (step 612). In the case of a failure, the report also gives a detailed message of the errors. A decision is then made as to whether more locale files are to be tested (step 614). If there are more locales to be tested, the operation returns to step 602, otherwise the operation ends.

The aspects of the present invention provide for collation regression testing. Collation elements are extracted from a locale seed file into an element list. From the element list a sorted list is generated both in a released product and an updated product that is being validated. The two lists are compared to produce test results indicating a passing or failing of the collation produced by the updated product as compared to the released product.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for collation regression testing, the method comprising:
extracting collation elements from a locale seed file into an element list;
generating a first sorted list from the element list in a first product;
generating a second sorted list from the element list in a second product; and
comparing the first sorted list to the second sorted list to produce test results.

2. The computer implemented method of claim 1, wherein the locale seed file is from a locale.

3. The computer implemented method of claim 1, wherein the first sorted list is generated using a collation function of the first product.

4. The computer implemented method of claim 1, wherein the second sorted list is generated using a collation function of the second product.

5. The computer implemented method of claim 1, wherein the first product is a released product.

6. The computer implemented method of claim 1, wherein the second product is an updated product.

7. The computer implemented method of claim 6, wherein the updated product is a product being tested for validation.

8. The computer implemented method of claim 1, wherein the comparison is based on at least one of the collation elements' code or binary representation.

9. The computer implemented method of claim 1, further comprising:
generating a test report based on the test results of the comparison.

10. The computer implemented method of claim 9, wherein the test results indicates at least one of pass or fail.

11. The computer implemented method of claim 1, wherein the locale seed file defines all collation elements, rules, time formats, monetary format and other related conventions for a locale.

12. The computer implemented method of claim 1, further comprising:
repeating the extracting, generating, and comparing steps for a plurality of locales that the first product supports.

13. A data processing system comprising:
a bus system;
a communications system connected to the bus system;
a memory connected to the bus system, wherein the memory includes a set of instructions; and
a processing unit connected to the bus system, wherein the processing unit executes the set of instructions to extract collation elements from a locale seed file into an element list; generate a first sorted list from the element list in a first product; generate a second sorted list from the element list in a second product; and compare the first sorted list to the second sorted list to produce test results.

14. The data processing system of claim 13, further comprising the processing unit executing a set of instructions to generate a test report based on the test results of the comparison.

15. The data processing system of claim 13, wherein the locale seed file defines all collation elements, rules, time formats, monetary format and other related conventions for a locale.

16. The data processing system of claim 13, further comprising the processing unit executing a set of instructions to repeat the instructions to extract, generate, and compare for a plurality of locales that the first product supports.

17. A computer program product comprising:
a computer usable medium including computer usable program code for collation regression testing, the computer program product including:
computer usable program code for extracting collation elements from a locale seed file into an element list;
computer usable program code for generating a first sorted list from the element list in a first product;
computer usable program code for generating a second sorted list from the element list in a second product; and
computer usable program code for comparing the first sorted list to the second sorted list to produce test results.

18. The computer program product of claim 17, further comprising:
computer usable program code for generating a test report based on the test results of the comparison.

19. The computer program product of claim 17, wherein the locale seed file defines all collation elements, rules, time formats, monetary format and other related conventions for a locale.

20. The computer program product of claim 17, further comprising:
computer usable program code for repeating the computer usable program code for extracting, generating and comparing for a plurality of locales that the first product supports.
